(19) United States
(12) Patent Application Publication
(10) Pub. No.: US 2010/0245259 A1
(43) Pub. Date: Sep. 30, 2010

(54) SMALL SCREEN DISPLAY WITH A DATA FILTERING AND SORTING USER INTERFACE

(75) Inventors: Abhijit Bairagi, Jamshedpur (IN); Ankur Jhawar, Bangalore (IN); Siddharth Ghule, Bangalore (IN); Pallavi Dharwada, Minneapolis, MN (US)

Correspondence Address: HONEYWELL/CST;Patent Services, 101 Columbia Road, P.O. Box 2245, Morristown, NJ, 07962-2245, US

(73) Assignee: HONEYWELL INTERNATIONAL INC., Morristown, NJ (US)

(21) Appl. No.: 12/411,183

(22) Filed: Mar. 25, 2009

(51) Int. Cl. G06F 3/041

(52) U.S. Cl. 345/173

(57) ABSTRACT

A navigation approach having a data filtering and sorting for a user interface with a small screen display. The user interface may be used with a building control system. The sorting may be accomplished with a single button filter/sort key which when clicked opens up a floating window containing various sorting options. The single button takes little screen real estate but provides a user the flexibility to arrange data in such a way that results in high speed of access and productivity.

Related patent applications include U.S. patent application Ser. No. ______, Attorney Docket No. H0021716-1161.1398101, filed Mar. 25, 2009, entitled “MECHANISM FOR INTERFACING A DISPLAY SCREEN OF ANOTHER TECHNOLOGY WITH A COMPUTING PLATFORM”; U.S. patent application Ser. No. ______, Attorney Docket No. H0022766-1161.1417101, filed Mar. 25, 2009, entitled “A SYSTEM FOR DEFINING A USER INTERFACE OF A REMOTE DISPLAY DEVICE”; U.S. patent application Ser. No. ______, Attorney Docket No. H0022777-1161.1418101, filed Mar. 25, 2009, entitled “An APPROACH FOR ADVANCED USER NAVIGATION”; U.S. patent application Ser. No. ______, Attorney Docket No. H0022474-1161.1419101, filed Mar. 25, 2009, entitled “AN AUTOMATIC CONFIGURATOR OF DISPLAY OBJECTS”; U.S. patent application Ser. No. ______, Attorney Docket No. H0022842-1161.1420101, filed Mar. 25, 2009, entitled “AN EMBEDDED COMPUTING SYSTEM USER INTERFACE EMULATED ON A SEPARATE COMPUTING DEVICE”; all of which are hereby incorporated by reference.

### BACKGROUND

The invention pertains to data management. Particularly, the invention pertains to such management having a user interface using a screen display in conjunction with a control system.

### SUMMARY

The invention is a navigation approach having a data filtering and sorting for a user interface with a small screen display. The sorting may be accomplished with a single button filter/sort key which when clicked opens up a floating window containing various sorting options. The user interface may be used for managing components of a building control system.

### BRIEF DESCRIPTION OF THE DRAWING

FIG. 1 is an illustrative diagram of an image of a home page on a small touch-screen display of a user interface for a building control system;

FIG. 2 is an illustrative diagram of an HVAC menu access page;

FIG. 3 is an illustrative diagram of a sort floating window for HVAC;

FIG. 4 is an illustrative diagram of the image of FIG. 2 but with sorted zones;

FIG. 5 is an illustrative diagram of an edit selection for a zone parameter;

FIG. 6 is an illustrative diagram of an edit screen or image for a selected parameter;

FIG. 7 is an illustrative diagram of an image showing edit confirmation of the selected parameter;

FIG. 8 is an illustrative diagram of a home page access image for getting lighting;

FIG. 9 is an illustrative diagram of a second level menu access image for lighting;

FIG. 10 is an illustrative diagram of a floating window image for sorting;

FIG. 11 is an illustrative diagram of the second level menu access image for lighting after the floating window image;

FIG. 12 is an illustrative diagram of an image showing an override button activation;

FIG. 13 is an illustrative diagram of an image showing a confirmation of the override;

FIG. 14 is an illustrative diagram of an image showing a canceling of an override of the change of status of lighting;

FIG. 15 is an illustrative diagram of an override edit image;

FIG. 16 is an illustrative diagram of a home page access for getting alarms;

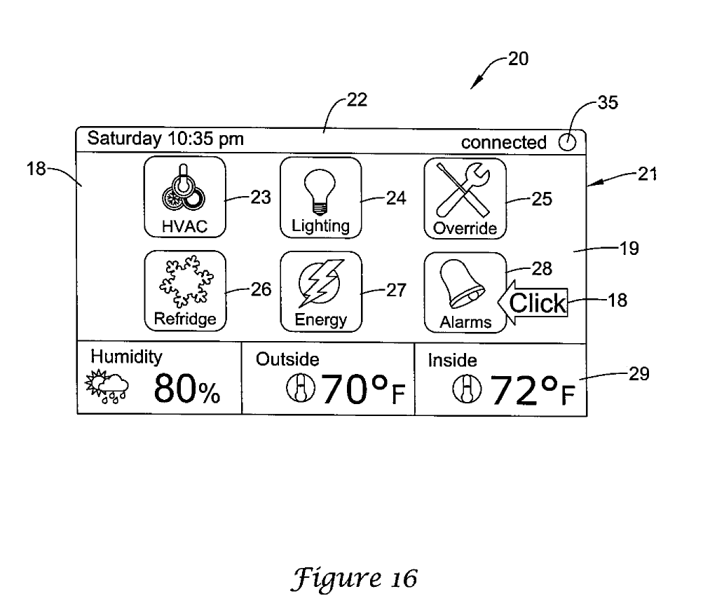

FIG. 17 is an illustrative diagram of a second level menu access for alarms;

FIG. 18 is an illustrative diagram of a third level menu access image for alarms;

FIG. 19 is an illustrative diagram of a floating window image for sorting alarm data;

FIG. 20 is an illustrative diagram of a sorted third level menu access image for alarms;

FIG. 21 is an illustrative diagram of a home access page for getting refrigeration;

FIG. 22 is an illustrative diagram of a first menu access image for refrigeration;

FIG. 23 is an illustrative diagram of a display selection image for refrigeration;

FIG. 24 is an illustrative diagram of an alternate home page for refrigeration;

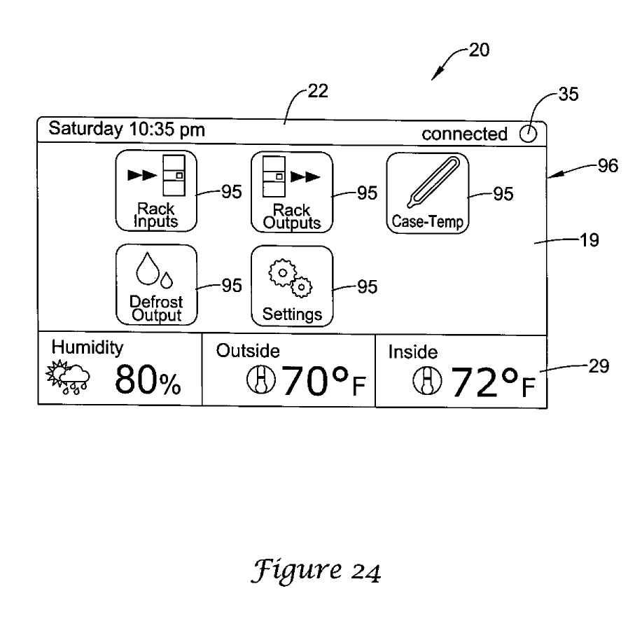

FIG. 25 is an illustrative diagram of another display selection image for refrigeration with a rack inputs selection to be made;

FIG. 26 is an illustrative diagram of a second level display selection image for refrigeration;

FIG. 27 is an illustrative diagram of a floating window image for sorting refrigeration data;

FIG. 28 is an illustrative diagram of the second level display selection image having sorted refrigeration data;

FIG. 29 is an illustrative diagram of another display selection image for refrigeration with a control settings selection to be made;

FIG. 30 is an illustrative diagram of a control settings use case image for refrigeration;

FIG. 31 is an illustrative diagram of a defrost options selection image for refrigeration;

FIG. 32 is an illustrative diagram of an MTA 1 Dairy Cooler selection image for defrost options;

FIG. 33 is an illustrative diagram of a forced defrost settings image for the MTA 1 Dairy Cooler;

FIG. 34 is an illustrative diagram of a forced defrost status image for the MTA 1 Dairy Cooler;

FIG. 35 is an illustrative diagram of a number of defrost cycles per day settings image for the MTA 1 Dairy Cooler;

FIG. 36 is an illustrative diagram of a maximum defrost settings image for the MTA 1 Dairy Cooler;

FIG. 37 is an illustrative diagram of a minimum defrost time settings image for the MTA 1 Dairy Cooler; and

FIG. 38 is an illustrative diagram of a changed defrost options image for refrigeration.

### DESCRIPTION

The limited space available in a small screen display means that a maximum of four to five lines of useful data can be displayed on it at a time. In related art, if the user has to go through large amount of data the only option seems to be having a scroll button which needs to be pressed multiple times to reach required data. Additional items like ‘Page Up’ and ‘Page Down’ buttons may take up valuable screen real estate.

The present navigation approach may address this challenge by allowing the user to sort through large amounts of data quickly with the help of a single button to arrive at the information of the user's requirement in a small touch screen interface. A button or icon may be an area in a screen or image on a display which may be touched with a finger or object to press or activate it. The button may also be activated or pressed with a mouse or arrow. The terms “image”, “page” and “screen” may be used interchangeably.

The present invention or system may improve on the sorting ability by introducing an approach of a single button filter/sort key which, when clicked opens up a floating window containing various sorting options which are contextual or otherwise to the data in the list. The present system may have a selection for operation with a choice of different languages.

For example, if the list contains all HVAC Alarms; the sorting filter for such use case may contain filters for arranging the list on the basis of criticality, time of occurrence, and alphabetical sorting (A-Z and Z-A). Depending on the requirement, a user can use the appropriate sorting button to prioritize the data he wants so that he can reach it much faster. There is also an option for resetting the sort to its default arrangement.

The invention may be very useful in small touch-screen interfaces where there are long lists of data that a user has to go through via scrolling. The single button filter does not take much of the screen real estate but gives a user the flexibility to arrange data in a way that improves on his speed of access and productivity.

In dealing with various items in screens or images being displayed, zones or mechanisms, for example, may have one or more parameters, status, settings, attributes, conditions, options, and/or the like, associated with them. These parameters, status, settings, attributes, conditions, options, and/or the like, may be referred generically with one term such as “property” or “properties”.

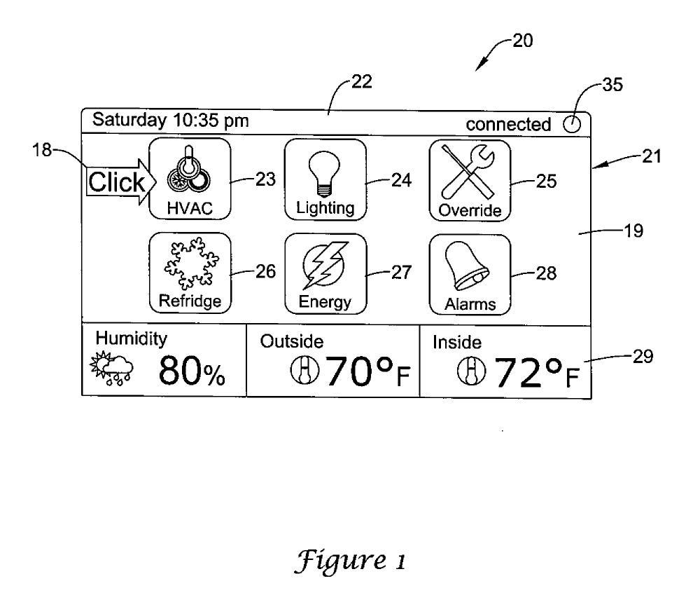

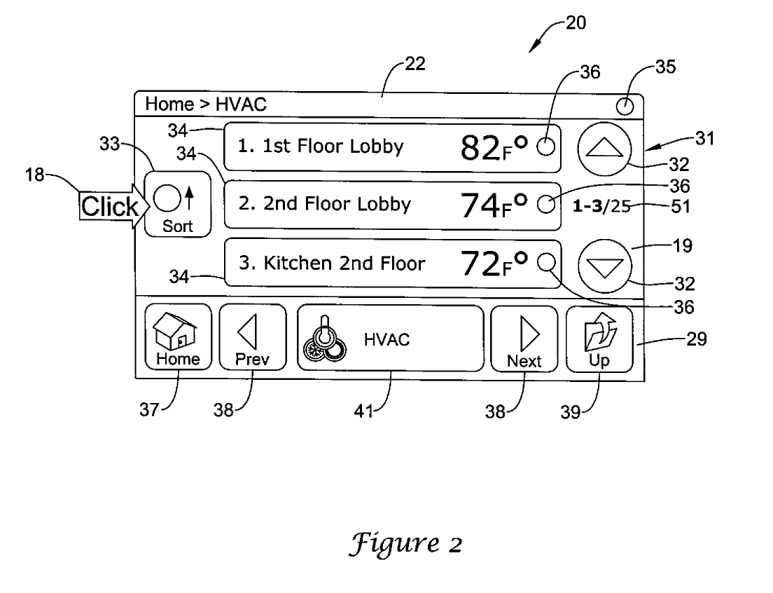

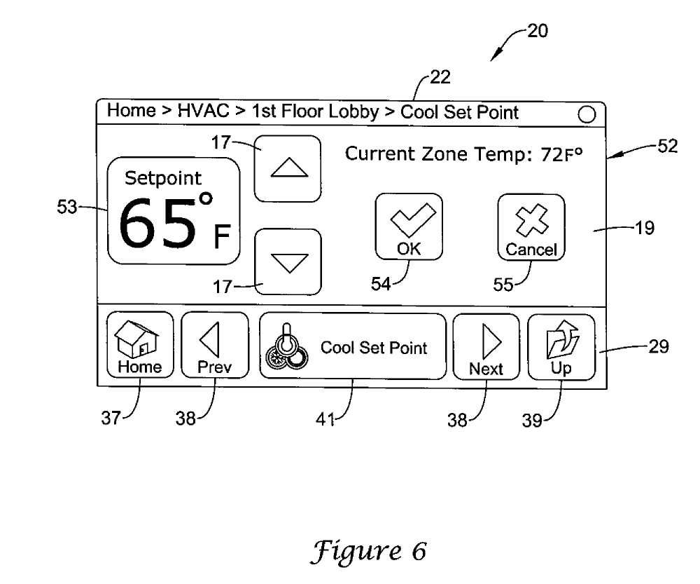

FIG. 1 is an image 21 of a home page on a small touch-screen display 20 of a user interface for a building control system. Image or screen 21 may also be regarded as an idle screen or image to the user. Image or screen 21 may show four lines of data. The top area 22 may have one line of data, the middle area 19 may have two lines of data and the bottom area may have one line of data. There may be more or less four lines of data. For instance, arguably the screen or image in a display 20 in FIG. 2 shows five lines of data and the display in FIG. 6 shows three lines of data. At the top of image 21 is a “bread crumbs bar” label in area 22 indicating the day and time, and whether the display is connected to the building control system as may be indicated by light 35. Other information may be in label 22, such as a sequence or levels of images that precede the present one on the display. The sequence may include the present image. Below label 22 in area 19 may be two rows of buttons 23, 24, 25, 26, 27 and 28 with icons representing components such as HVAC, Lighting, Override, Refridge, Energy and Alarms, respectively. Other icons may be present in lieu of the existing icons or there may be additional buttons or other icons. Area 19 may be regarded as a text field. Area 19 may be a user customizable area. The bottom line or lower area 29 of information may include such things as humidity, and outside and inside temperatures of a locale. On the other hand, area 29 may be a navigation bar having home, previous, next and up buttons. Area 29 may have a block or label indicating the current item on the screen or in the image of a display. The image or screen could do without the upper area 22 and lower area 29 thereby resulting in a small useable display having three or less lines.

To provide an illustrative example demonstration of the interface, one may click on button 23 or an HVAC icon to activate it as indicated by a symbol click 18. The click or activation 18 may be caused by a touch with a finger or object, or by a mouse with a displayed arrow. This example may utilize a touch for activation of items on the display. The HVAC icon may optionally be red if there is an alarm condition in any of the zones. The icon, button or item 23 (these terms may be used interchangeably) may be activated.

Upon activation of the HVAC icon, an HVAC second level menu access page or image 31, shown in FIG. 2, may appear on display 20. The bread crumbs label in area 22 may indicate “Home>HVAC”. Area 19 of image displays the first three zones 34 out of 25 zones. The zone list may be scrolled with up and down buttons. The information for each zone indicates a numerical order, the name and the ambient temperature. Also, an indicator light 36 may be in each zone bar 34 of information. Light 36 may be used for various kinds of indications such as an alarm, override or other condition. As an alarm indicator, light 36 may be green as if no problem exists or red if there is a problem. The bottom area 29 of information may have a home button 37 for returning to the home page, previous and next buttons 38 for returning or advancing to the previous image or a next image, respectively, on screen 20. An “up” button 39 may be in the bottom area 29, for returning screen display 20 to an image of a higher level of information. A label of the component, zone, or the like, selected from the previous image may be indicated in block 41 of area 29.

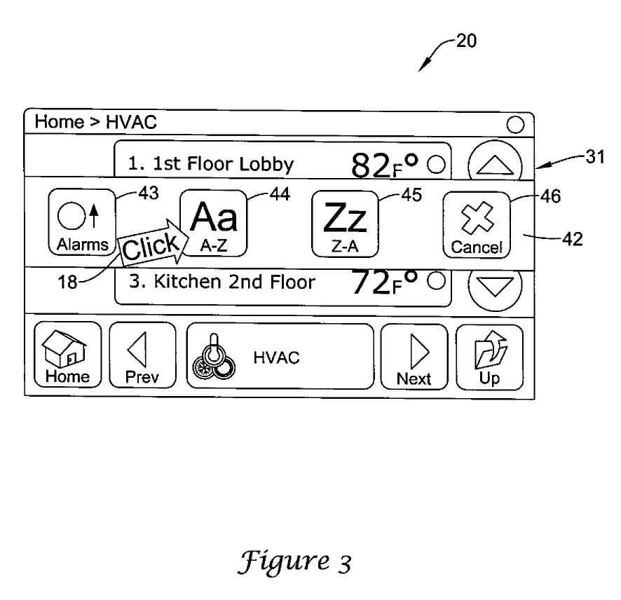

The sort button 33 in image 31 may be activated with a click or touch 18 to get a floating window 42 that is superimposed on image 31 which may be dimmed during the presence of the floating window, as shown in FIG. 3. Floating window 42 may reveal a number of sorting criteria, three of which are shown. The alarms button 43 may place alarm zones at the top, button 44 may sort the zones alphabetically, and button 45 may sort the zones in reverse alphabetical order. Button 46 may cancel floating window 42 and return back to image 31 of FIG. 2 without affecting the order of the 25 zones. Other criteria of sorting may include sorting according to context, such as type of space, temperature level, location in building, criticality, overrides, most recent edits, customized preference, or a reversal of any order. There may be other criteria of sorting.

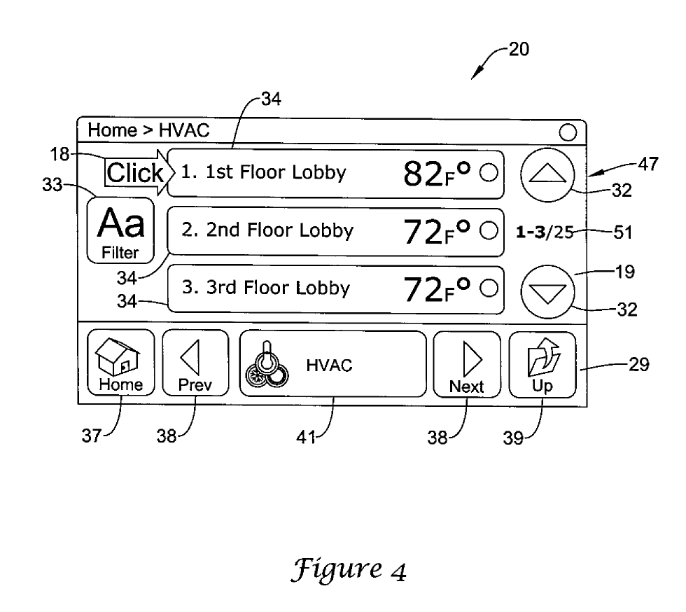

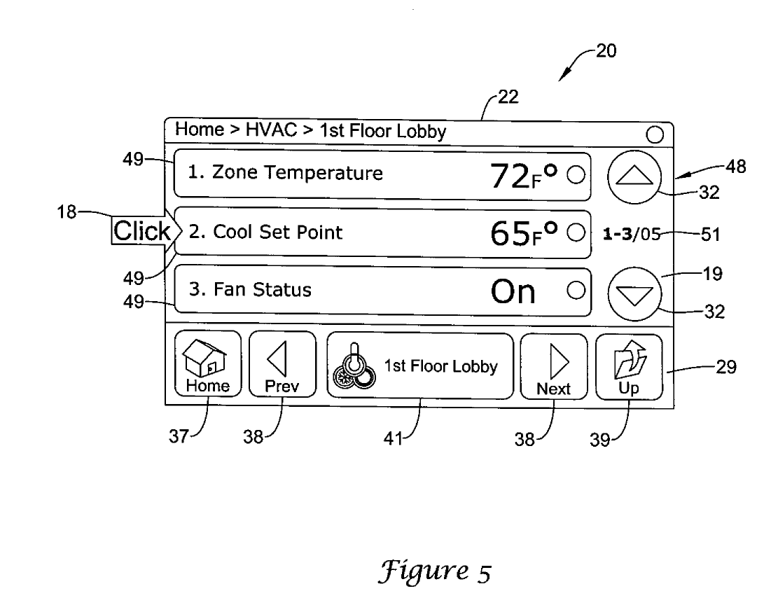

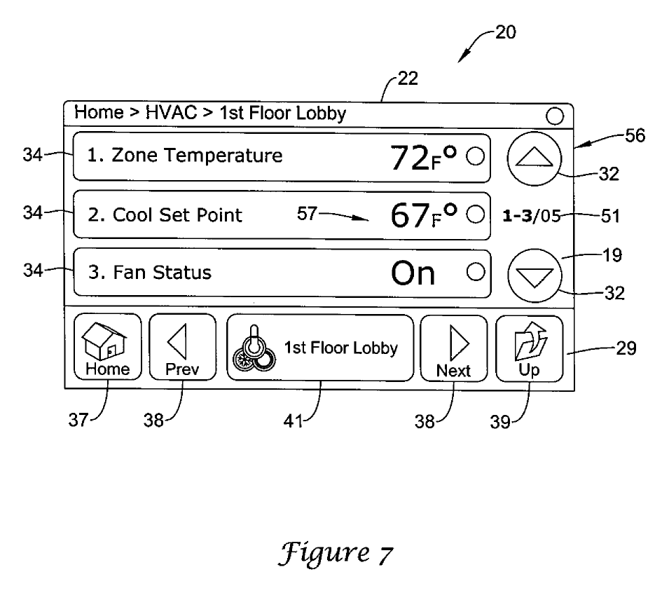

FIG. 3, as an example sort, shows button 44 to be activated with a click 18. This may result in an image 47 in FIG. 4 similar to image 31 of FIG. 2 but with a different order of zones done according to button 44 of an alphabetical sort in FIG. 3 and now indicated by sort button 33 as an “Aa” filter in FIG. 4. The first zone area or button 34 may be activated with a click 18 to get an image 48 in FIG. 5 which may show parameters, set points, status, and so on in blocks or areas 49 of the first listed zone in image 47 of FIG. 4. Image 48 is an edit selection layout where one may select a parameter, set point, status or other item for editing. Scroll buttons 32 may be used to show blocks or areas 49 of other parameters, set points, status or other items. In image 48, three of a total of five items are shown which may be indicated by nomenclature 51. Nomenclature 51 may be referred to as an item indicator. Block 41 and area 22 indicate the first zone, “1^{st} Floor Lobby”, to be the topic of screen 48. For an example, block 49 containing “cool set point,” revealing the present set point at 65 degrees F., may be activated with a click 18. This may lead to an image 52 on display 20, as shown in FIG. 6, which is an edit screen for editing or changing the cool set point. Block 41 reveals the topic or title of image 52, as does area 22. Area 22 reveals the hierarchy of screens from the home page image 21 to the present image 52. Area 19 shows a set point block showing 65 degrees F. which may be edited or adjusted with up and down buttons 17 to another temperature such as 67 degrees F. The current zone temperature may be shown. Once the set point temperature in block 53 is changed, the new value may be accepted by clicking on an “OK” button 54. If one wants to return to the same set point, then a “cancel” button 55 may be clicked to return to an image showing the list of parameter, set point, status blocks 34, as shown by image 56 in FIG. 7. The cool set point block 34 in image 56 reveals that it was changed to 67 degrees F. from 65 degrees F. due to an edit conducted at image 52 of FIG. 6. The previous set point may be indicated as being overridden by an icon 57 which appears as a crossed wrench and screwdriver. That indicates that the new setting can be validated in the edit confirmation image 56. The new set point value in image 56 indicates the override temperature and could indicate the time remaining for the override value if not confirmed.

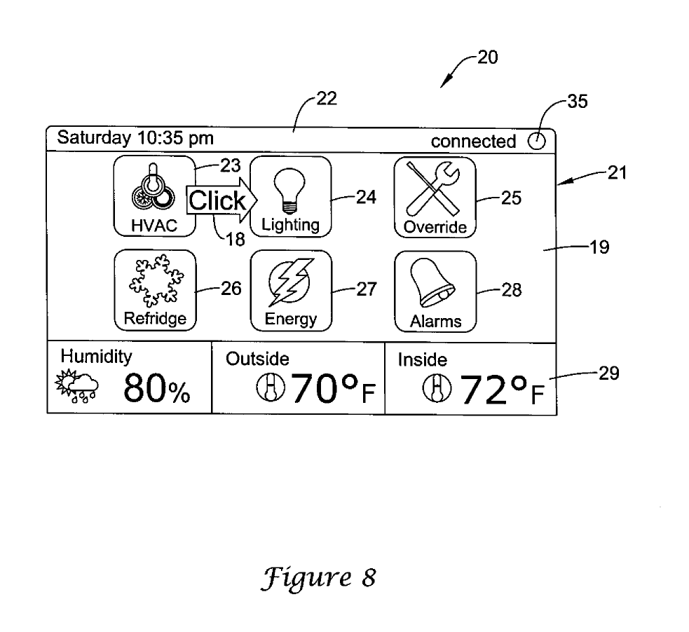

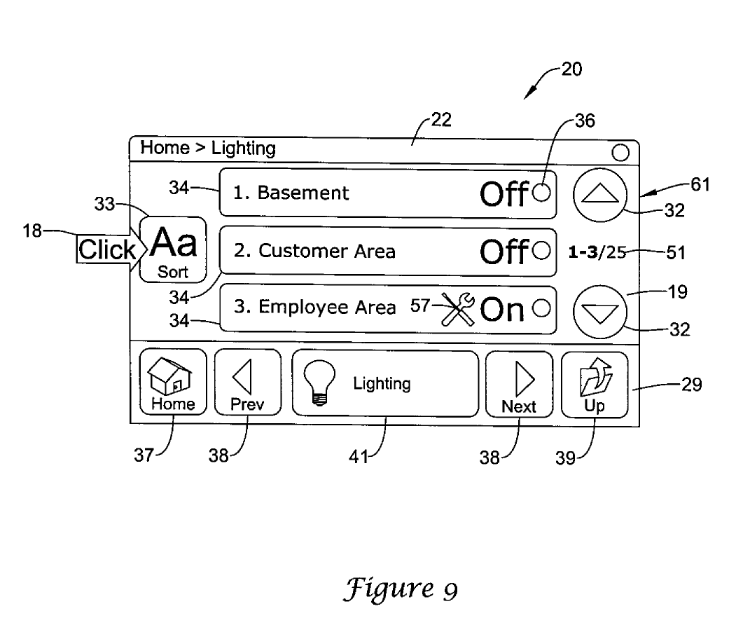

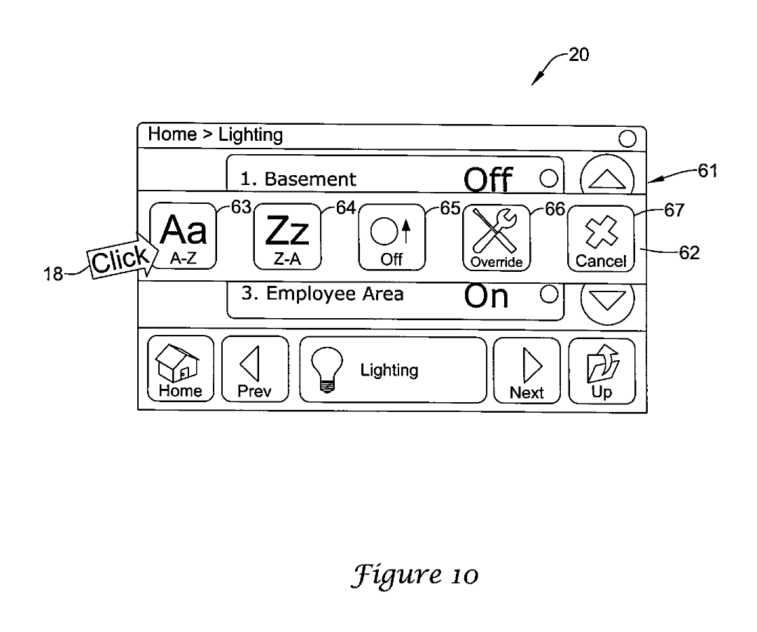

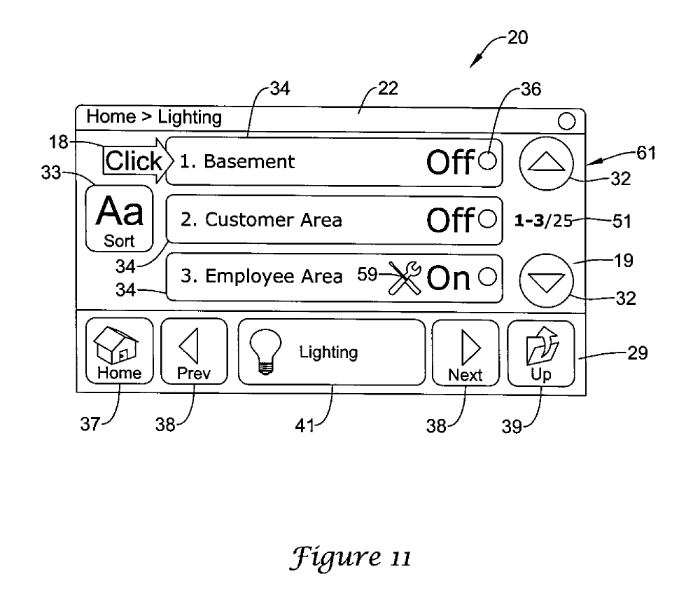

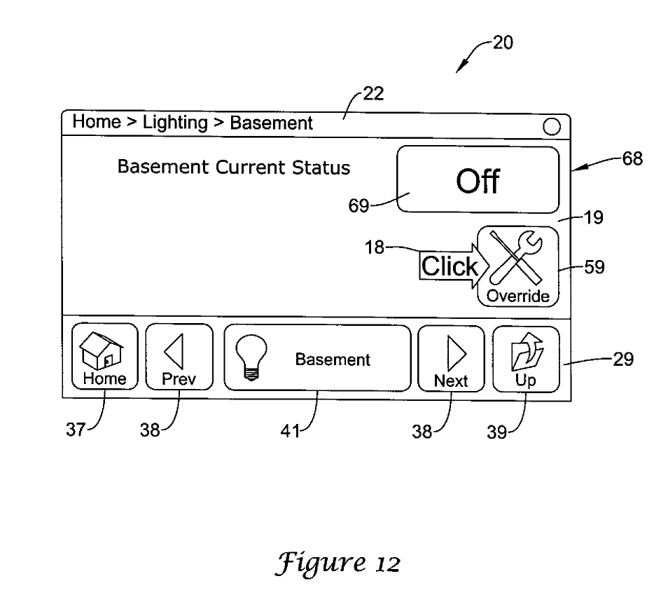

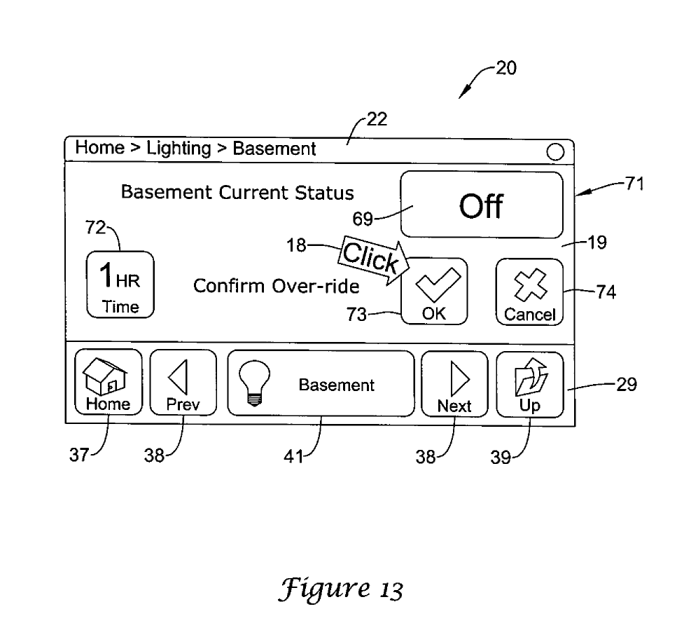

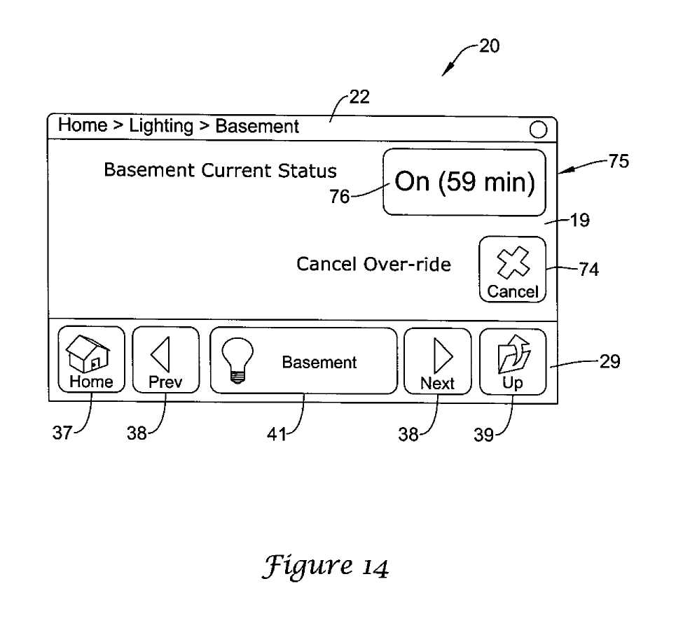

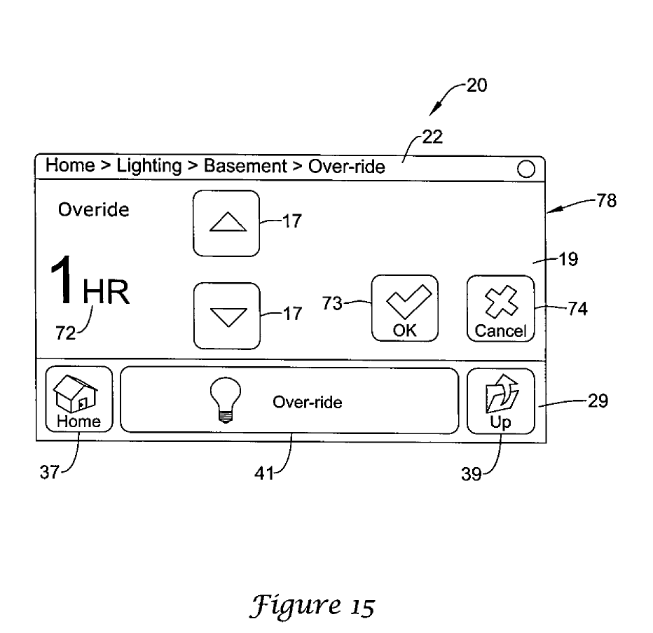

One may return to the home page as shown in image 21 of FIG. 1 and also FIG. 8. Another component, such as a lighting icon 24, showing a light bulb, may be activated with a click 18. As a result, an image 61 may appear as shown in FIG. 9, which may be regarded as a second level menu access. A list of zones 34 is shown with the status of lighting, on or off, indicated for each zone. Buttons 32 may be used to scroll up and down the list of 25 zones as noted by indication 51. Sort button 32 indicates that the zones are alphabetically sorted. One may note block 34 for the employee area having an override icon. The default sorting may be alphabetical but if there is an override condition, then the zone list may be sorted with the override zones at the top. One may do a click 18 on a sort button 33 and get a floating window 62 as shown in FIG. 10. Window 62 reveals buttons or icons 63, 64, 65, 66 and 67, representing alphabetical sorting, reverse alphabetical sorting, off, override and cancel, respectively. There may be other criteria for sorting including context, like the override sorter which can put the override zones at the top of the zone list. One may activate button or icon 63 with a click 18 to get effectively the same screen as in FIG. 9, since the same sort was selected, in FIG. 11. One may do a click 18, on the basement zone block 34 to get an image 68 for obtaining a lighting change of status of light (e.g., override), as shown in FIG. 12. The current status of lighting in the basement may be indicated by a block 69 noting that the lights are off. The “off” status may be changed to an “on” status by doing a click 18 on the override icon 59 in area 19 of screen 68, which changes the current status by generating the override. This click 18 may lead to an image 71 as shown by FIG. 13, which is for the change of status of light which shows the amount of time in block 72. The override may be confirmed by doing a click 18 on the “ok” button 73 or the override may be canceled with a click 18 on a cancel button 74. A click 18 on the “ok” button 73 may result in an image 75 in FIG. 14, which shows a change of status of lighting to “on” as indicated by a block 76, which also indicates an amount of time (e.g., 59 minutes) remaining for the override. This image 75 is a confirmation screen which may be used to cancel the override by doing a click 18 on a cancel button 77. If the override is not canceled in image 75, then an image 78 may appear, as shown in FIG. 15, which may be regarded as an override edit screen. The override time period as indicated in block 72 may be a parameter that is adjusted by pressing or doing a click 18 on up and down buttons 17. The override with an indicated amount of time may be accepted with the ok button 73 or rejected with the cancel button 74.

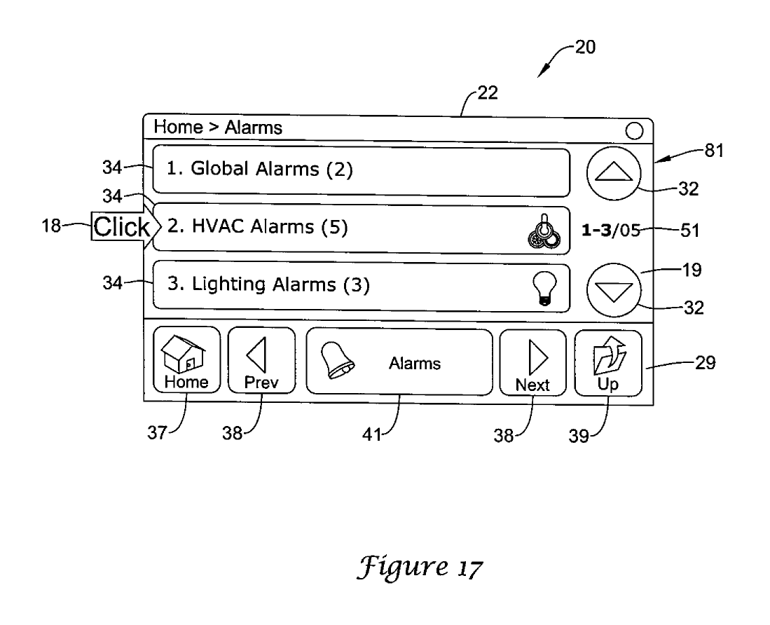

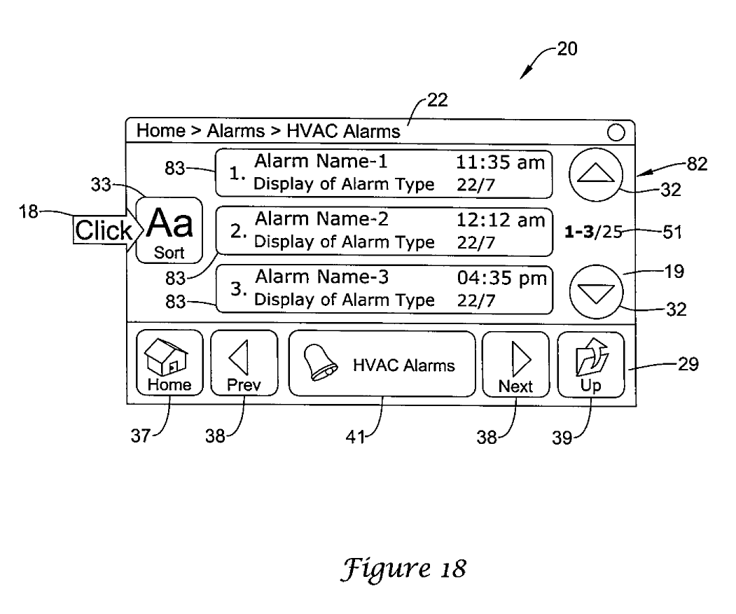

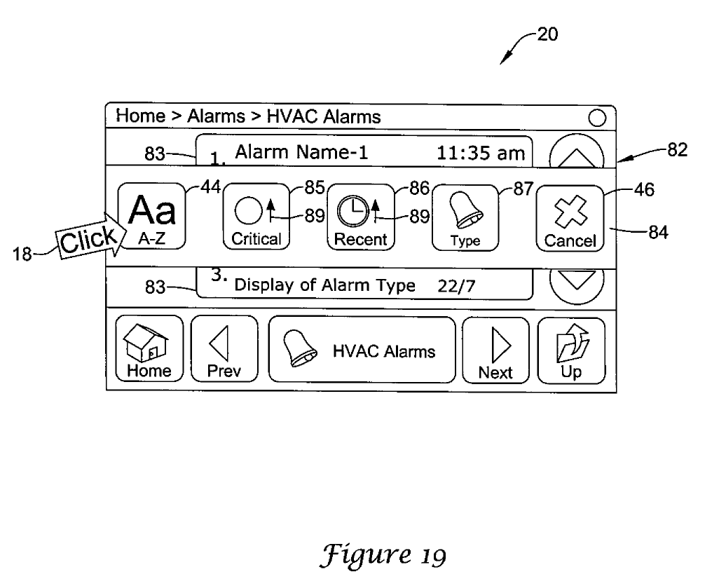

The home page access screen or image 21 may be resorted to for selecting another component. The alarms icon 28 may be red if there is an alarm condition in any of the zones. To look at alarms, one may do a click 18 on component or icon 28 in FIG. 18, which may result in an image or screen 81 in FIG. 17, showing an alarms second level menu access. There is no sorting in this level having separate folders or blocks 34 for the alarms of each component. The folders list may be scrolled, as needed for access, with scroll buttons 32. Indication 51 notes a total of five folders. One may do a click 18 on HVAC alarms in a block 34 to result in an image or screen 82, as shown in FIG. 18, at an alarms third level menu access. Three alarms of the 25 as per indication 51 are shown in area 19. The present sort as indicated by sort button 33 appears alphabetical. Each alarm block 83 of image 82 may show the alarm name, alarm type, and the date and time of the alarm. Doing a click 18 on button 33 may result in a floating window 84 as shown in FIG. 19. Sorting options or criteria may include alphabetical, critical, recent occurrences, and type, as indicated by icons 44, 85, 86 and 87, respectively. A small arrow 89 in a sort icon may indicate a direction of the sort. Other options or criteria may be incorporated. Doing a click 18 on one of the buttons 44, 85, 86 and 87 will sort the alarms according to the criteria indicated by the respective icon. The sort of window 84 may be canceled with the cancel icon or button 46.

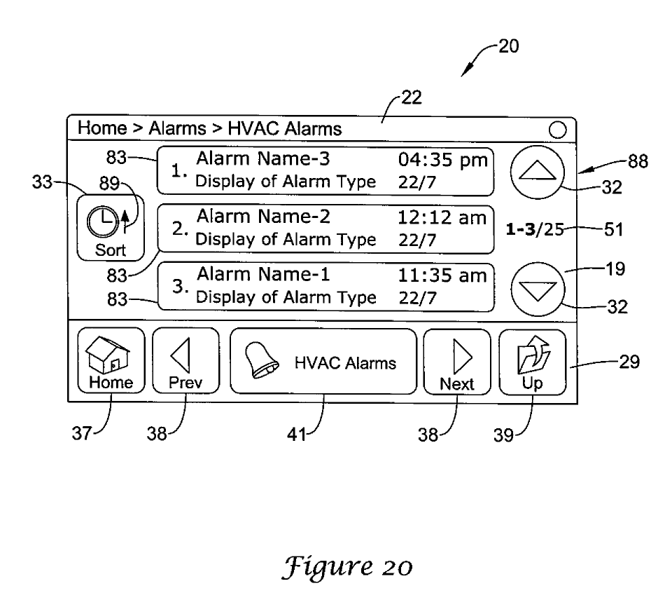

Doing a click 18, for example, on the icon or button 86 may sort the alarms with each listed alarm being more recent than the alarm below it, as indicated by screen or image 88 as shown in FIG. 20. The sort in effect may be indicated by the icon shown in button 33, which in image 88 is the icon 86 of floating screen 84 of FIG. 19. One may go to a higher level of display with button 39 or to a previous screen or image with button 38. The home page image 21 may be returned to with button 37.

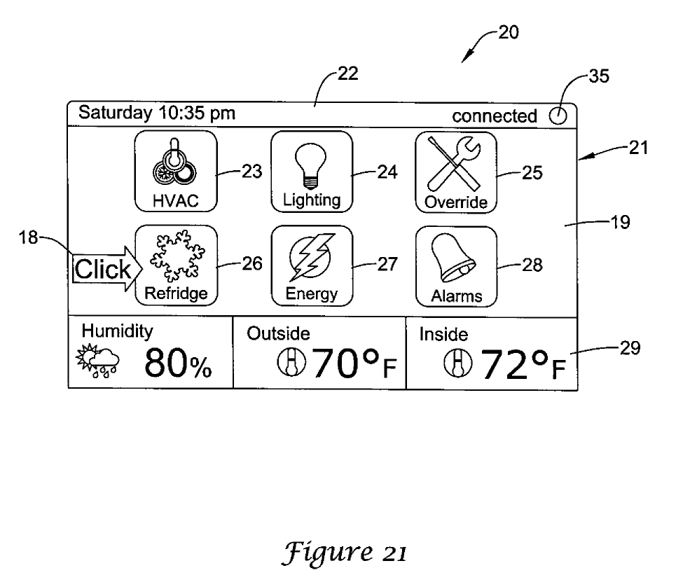

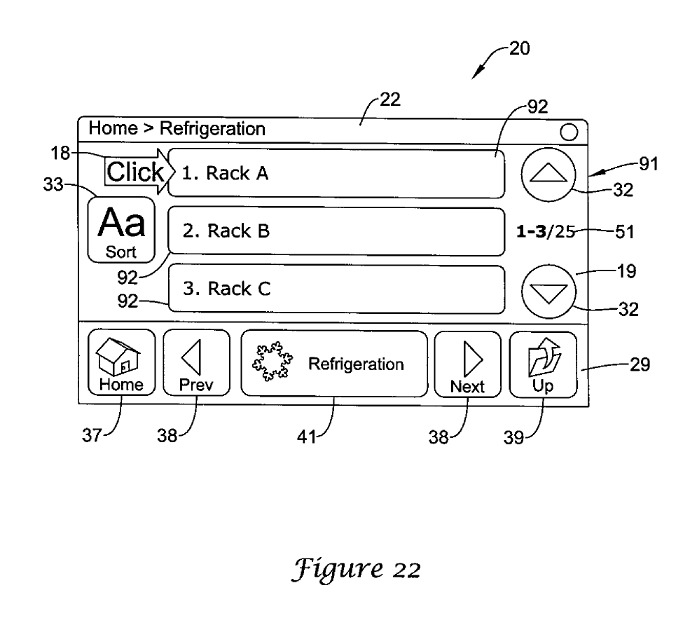

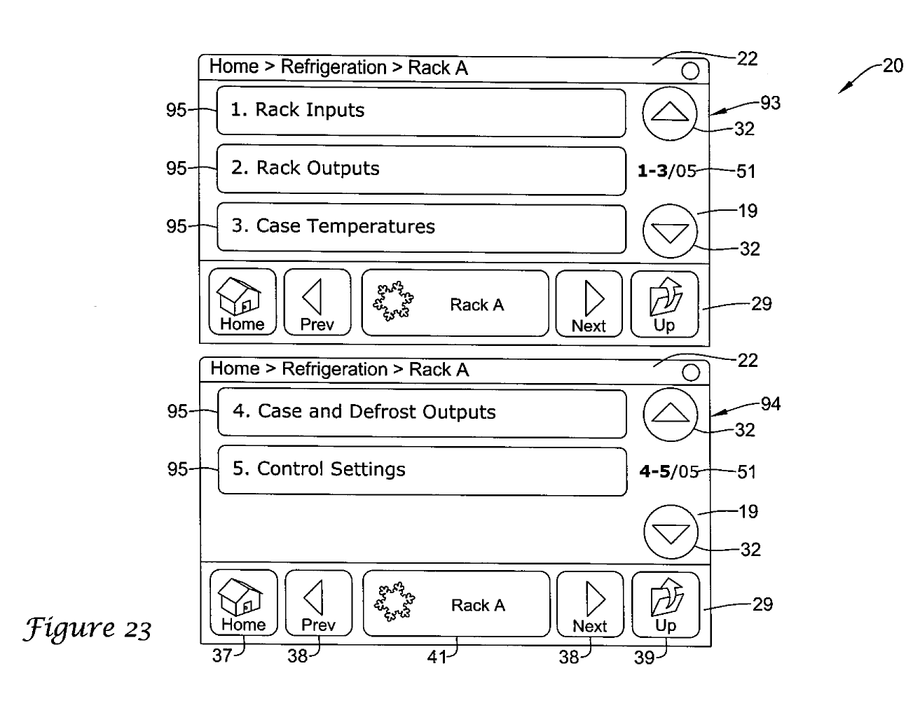

FIG. 21 shows the home page access image or screen 21 on display 20. A click 18 may be done on icon 26 representing the refridge component, to get a screen or image 91 having a refrigeration first level menu access, as shown in FIG. 22. Image area 19 of image 91 shows blocks 92 of three racks of a total of 25 according to indication 25. The racks appear sorted alphabetical as indicated by the icon in the sort button 33. A click 18 may be done on the block 92 listing rack A which as an illustrative example may result in images or screens 93 and 94 of a refrigeration display section showing five parameters, settings, options or other properties of rack A in blocks 95, as shown in FIG. 23. These parameters, settings, options, or other properties in rack A may include rack inputs, rack outputs and case temperatures, as shown in screen 93. One may scroll down to the other two parameters, settings, options or properties of the five, as revealed by indication 51, of rack A with a scroll button 32, as shown in image or screen 94 of FIG. 23.

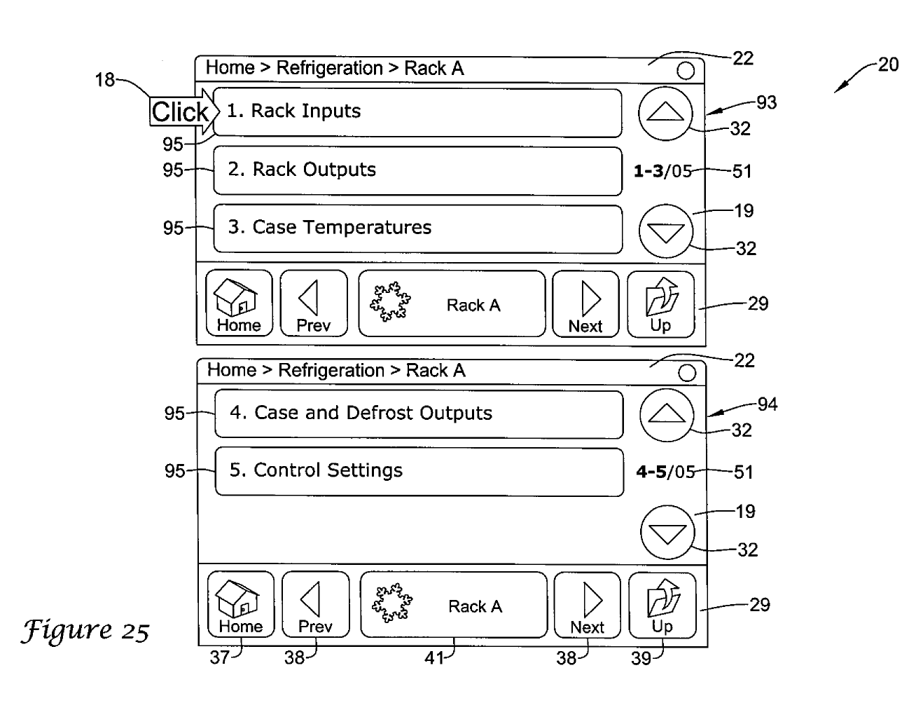

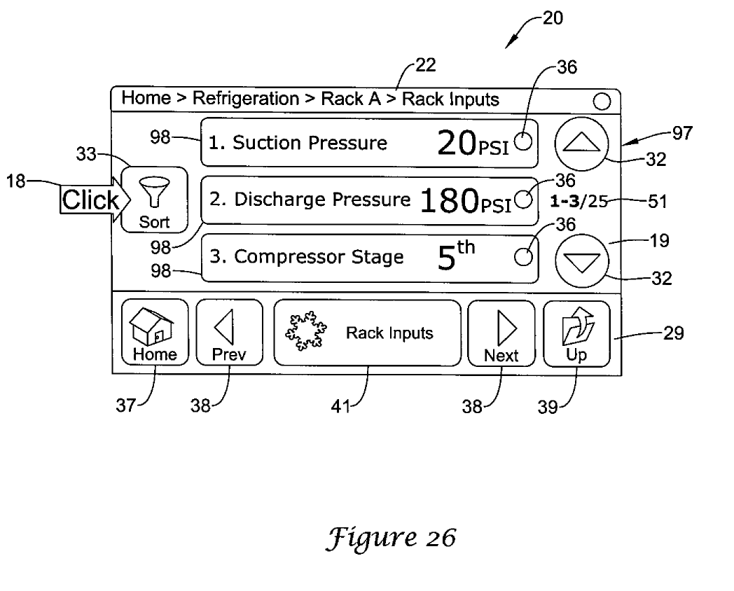

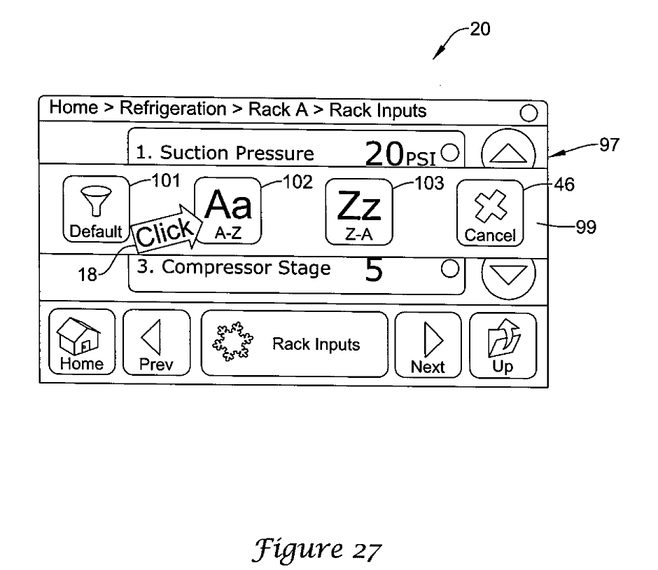

In the case of a refrigeration specific user interface with a single rack, these parameters, settings, options or properties may be shown in an icon based screen or image 96 as a refrigeration home page. One may return back to the standard screen or images 93 and 94 with display selection as in FIG. 23, except with a click 18 situated on the rack inputs in the top block 95, as shown in FIG. 25. Doing the click 18 may result in a screen or image 97 as shown in FIG. 26. Image 97 reveals a second level display selection for refrigeration. Three listed items of the twenty-five noted by indication 51 in blocks 98 may indicate suction pressure of 20 psi, discharge pressure of 180 psi and a 5^{th} compressor stage. Lights 36 may be alarm indicators which will be red or green depending on whether the current value is at or above the preset value. A click 18 may be done on the sort button 33 to result in a floating window 99 as shown in FIG. 27. The sort options may include a default icon (resembling a funnel) 101, an alphabetical order 102, and a reverse alphabetical order 103. Other sorting options may be included. For example, another sorting option may include sorting by alarm. The default button or icon 101 may restore the normal order of the options. The normal order may be determined on the basis of usage. The sorting selection or floating window 99 may be canceled with the cancel button 46.

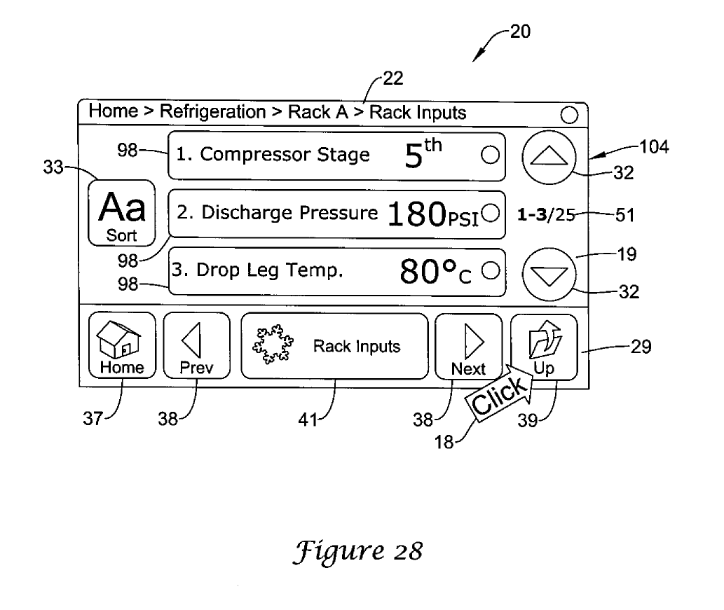

One may do a click 18 on button 102 to result in a screen or image 104 as shown in FIG. 28. Image 104 is similar to image 97 in FIG. 28 except for a different sort that results in the some of the rack inputs being in blocks 98 having another order. Image 104 is of a second level display selection for refrigeration like that of image 97. One may scroll through the rack inputs with buttons 32.

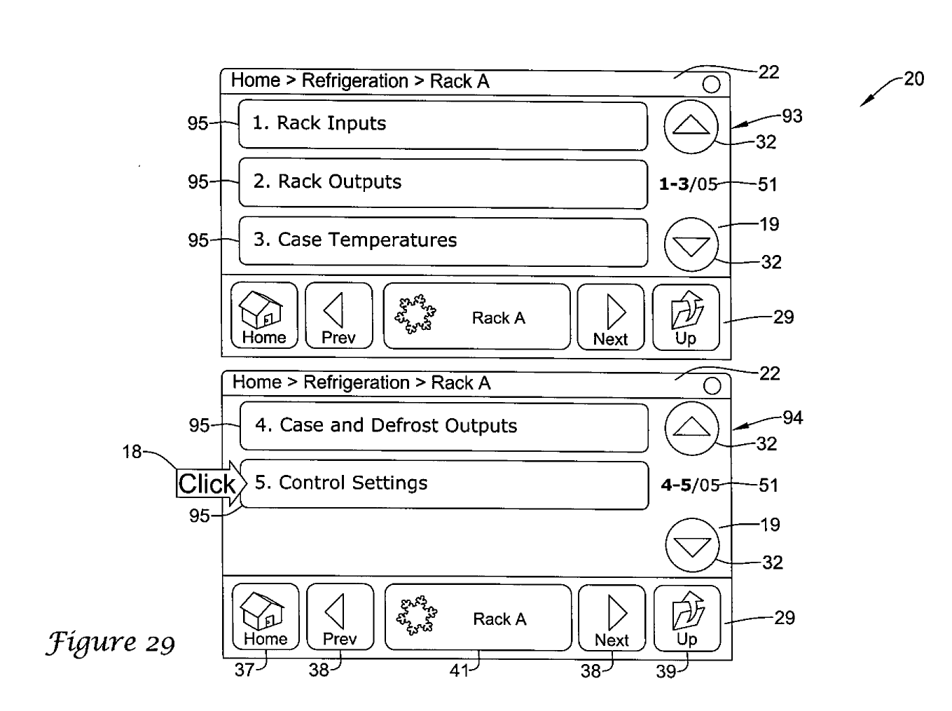

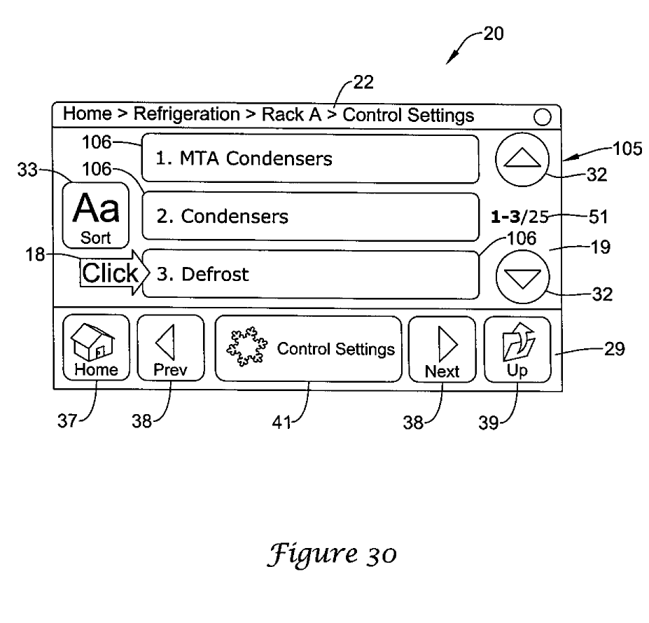

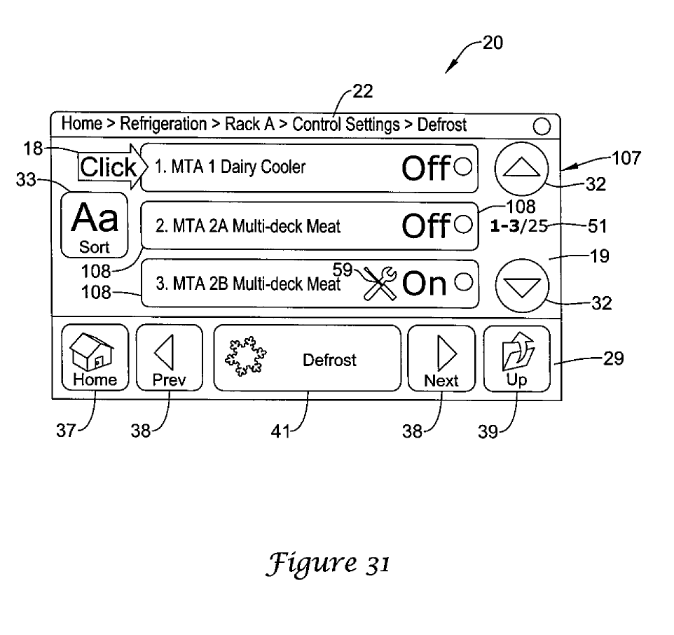

A click 18 may be done on the up button or icon 39 to return to the refrigeration display selection in images 93 and 94 of FIG. 25 which are shown in FIG. 29 with the click 18 positioned on control settings of a block 95 rather than the rack inputs. A click 18 may be done on “control settings” of block 95 to result in an image or screen 105 in FIG. 30. Three of the twenty-five control settings are shown as “MTA Condensers”, “Condensers” and “Defrost” in blocks 106. One may note that the sort of block 106 items is not necessarily alphabetical. That may be changed by pressing the sort button 33. A click 18 may be done on the “Defrost” block 106 to result in a screen or image 107, as shown in FIG. 31, with defrost options. Three of the twenty-five defrost options as noted by indication 51 are shown in blocks 108 as an “MTA 1 Dairy Cooler” shown with an “Off” status, “MTA 2A Multi-deck Meat” shown with an “Off” status, and an “MTA 2B Multi-deck Meat” with an “On” status and an override icon 59.

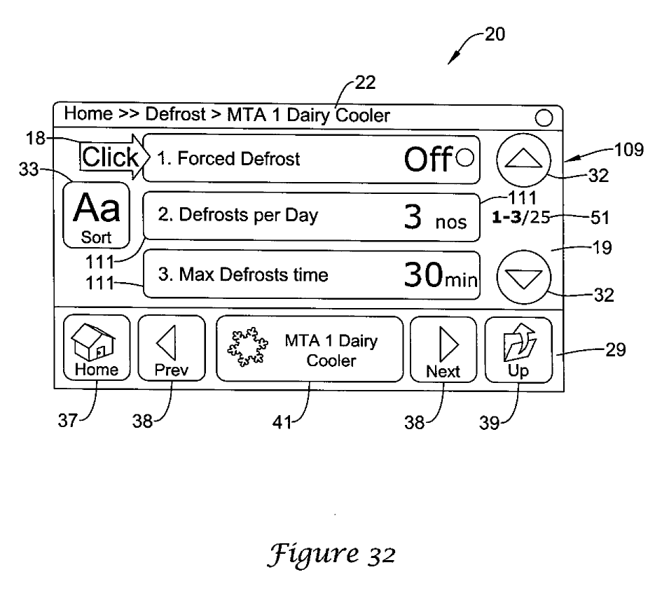

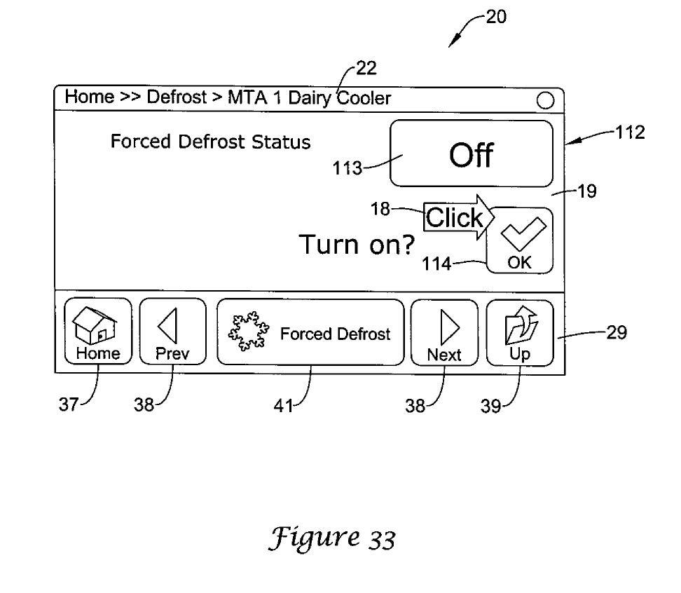

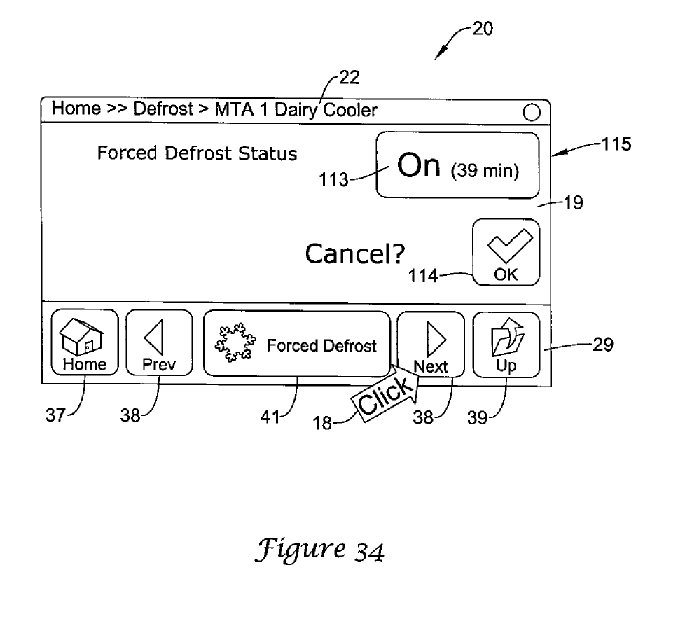

A click 18 may be performed on option 1, “MTA 1 Dairy Cooler” to result in an image or screen 109 as shown in FIG. 32. Three of the twenty-five dairy cooler options are listed in blocks 111 in area 19. The first three may include “Forced Defrost” with an “Off” status, “Defrosts per Day” with “3 nos” and “Max Defrosts time” at “30 min”. The other options may be obtained with scroll buttons 32 to seek other information and a status of them. A click 18 may be done on item 1, “Forced Defrost”, to get a combined “display/edit” screen or image 112 in FIG. 33, which shows the refrigeration forced defrost settings. The status “Off” may be indicated in a block 113 of area 19. If the status is to be changed to “On”, a click 18 may be done on an “OK” icon or button 114, to get a screen or image 115 as shown in FIG. 34 which indicates the forced defrost status to be “On” as indicated by block or button 113 in area 19. The text field 19 may indicate the current status with the change status button 113. The “On” status may be canceled with an OK button 114.

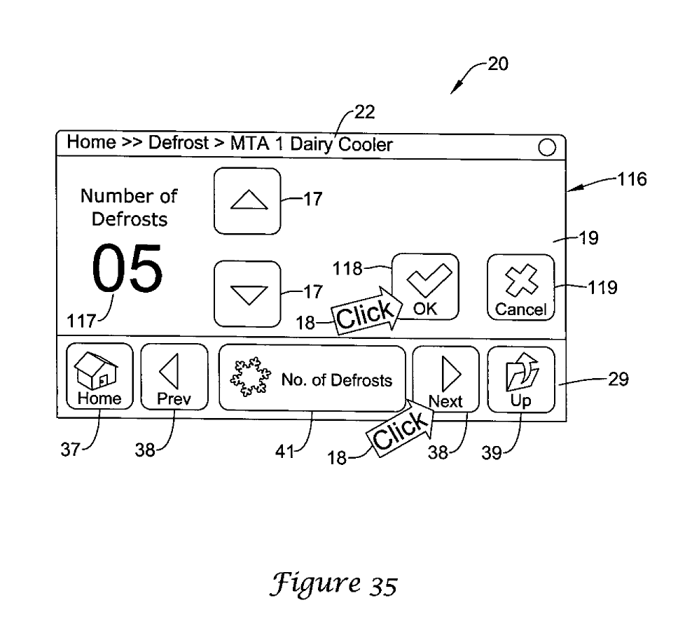

By doing a click 18 on the “Next” button 38 and the “Prev” button 38, one can scroll through the options, at the same level as images 112 and 115, and have the option of editing virtually any value. For instance, a click 18 may be done on the “Next” button 38 to take one to the next editable/display option on the list shown in screen 109 of FIG. 32, which is the number of defrost cycles per day settings as shown in image 116 of FIG. 35. Block 117 shows the number of defrosts at “5”. This number may be increased or decreased with up and down buttons 17. An “OK” button appears when a user adjusts the spinner or block 117 to a new value. Doing a click 18 on the OK button 118 may commit block 117 to the new value. A cancel button 119 restores the spinner or block 117 to the previous or earlier value.

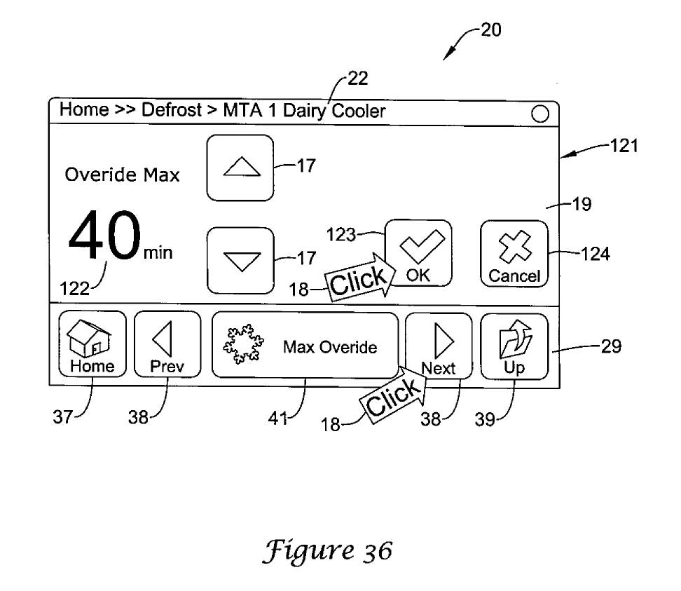

The “Next” button 38 may be activated with a click 18 to move from screen 116 to a screen 121 which is the next editable/display option on the list shown in screen or image 109 of FIG. 32, which is the “Max Defrost time” settings. Image or screen 121 is shown in FIG. 36. The time setting may be shown in a block 122 which is an “Override Max” indicating “40 min”. The time setting may be changed in value with the up and down buttons 17. An “OK” button 123 generally appears only when a user adjusts the spinner or block 122 to a new value. Activating the OK button 123 with a click 18 commits the setting to the newly set value in block 122. Activating a cancel button 124 restores the earlier or previous value in block 122. The spinner or block 122 may be scrolled in five minute increments in screen or image 121.

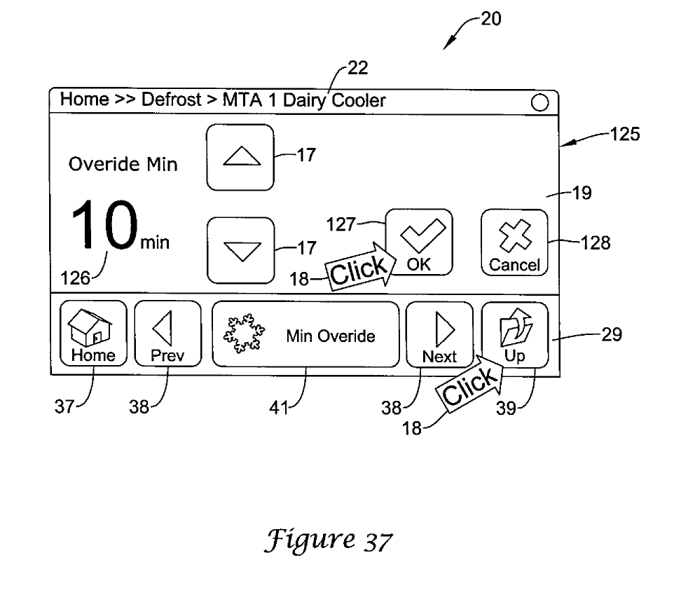

Doing a click 18 on the Next button 38 on image 121 of FIG. 36 may result in another defrost option which is “Min Defrost time” settings as shown by screen or image 125 of FIG. 37. The time setting which may be indicated is an “Override Min”. This time value may be indicated in a spinner or bock 126 which is shown as “10 min”. An “OK” button 127 generally appears only when a user adjusts the spinner or block 126 to a new value. Doing a click 18 on button 127 commits the spinner to the new value which may be entered with the up and down buttons 17. Doing a click 18 on a cancel button 128 restores the spinner or block 126 to the earlier or previous value. The value in the spinner or block 126 may be moved in increments of five minutes in screen or image 125.

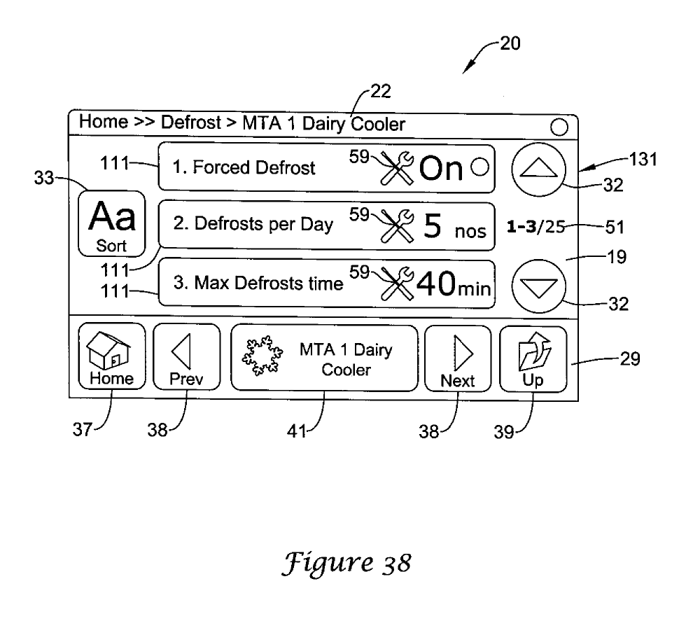

Doing a click 18 on “up” button 39 in screen 125 may return display 20 to the list of defrost options, like that in image or screen 109 of FIG. 32, but having some changed values as shown in image or screen 131 of FIG. 38. The changed values may have an override icon 59 displayed next to them.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. method for operating a screen display for a building control system, comprising:
providing a screen display for showing images;
observing a first image showing a home page having one or more buttons for representing components of a building control system;
activating a button of the one or more buttons to get a second image showing one or more zone icons; and
activating a sort button to sort two or more zone icons according to a default or a selected criterion.

2. The method of claim 1, wherein:
upon activating a sort button, a floating window appears superimposed on the second image;
the floating window shows buttons representing criteria for sorting; and
activating a button representing a criterion for sorting two or more zones according to the criterion.

3. The interface of claim 1, wherein a criterion of the sort button is selected from a group of criteria comprising an alphabetical order, a contextual order, a basis of criticality order, time of occurrence, an order of zones having an alarm condition being first, an order of zones having override conditions being first, an order of most recent edits, an order of customized preference, and a reversal of an order.

4. The interface of claim 1, further comprising:
activating a zone icon to get a third image showing one or more property icons of the zone icon;
activating a property icon to get a fourth image showing the property and adjust buttons for editing the property;
activating an accept edit button or a cancel button; and
returning to the third image for editing another property, going to another image, or stopping.

5. The method of claim 4, further comprising:
activating a scroll button to display a desired zone icon prior to activating a zone icon; and
wherein activating an icon or button is accomplished by touching the icon or button in the display.

6. A user interface for a building control system comprising:
a small touch-screen display for showing images, connected to a building control system; and
wherein:
certain places of the images may be touched via the display for activation;
a first image is for showing a home page having one or more buttons representing one or more components, respectively, of the building control system;
upon activating a button representing a component in first image, a second image appears;
the second image is for showing a list of one or more zones and a sort button;
upon activating the sort button, a floating window appears superimposed on the second image;
the floating window comprises a set of selectable sorting criteria; and
upon activating a criterion of the set of selectable sorting criteria or a cancel button, the floating window disappears and the zones of the second image are sorted;

7. The interface of claim 6, wherein a criterion of the sort button is selected from a group of criteria comprising an alphabetical order, a contextual order, a basis of criticality order, time of occurrence, an order of zones having an alarm condition being first, an order of zones having override conditions being first, an order of most recent edits, an order of customized preference, and a reversal of an order.

8. The interface of claim 6, wherein the sort button provides a filter for arranging data according to a user's preference.

9. The interface of claim 6, wherein the floating window further comprises an override sorting order that prioritizes over-ride zones among an order of items.

10. The interface of claim 6, further comprising:
upon activating a zone icon on the second image, a third image appears showing a list of one or more parameters or conditions of the zone;
upon activating a parameter or condition icon on the list of one or more parameters or conditions, a fourth image appears showing the parameter or condition adjust buttons;
upon activating one of the adjust buttons, the parameter or condition is edited;
upon activating an accept button or a cancel button, the edit is accepted or canceled,
respectively, with a return to the third image; and
upon activating a home button, a there is a return to the first image.

11. The interface of claim 10, wherein a sequence of first through fourth images can be repeated for another component, zone and parameter or condition, respectively.

12. The interface of claim 10, wherein:
the second and third images comprise scroll buttons; and
the second, third and fourth images comprise previous and next image buttons.

13. A method for operating a small touch screen display user interface for a building control system, comprising:
observing a first image on a screen showing a homepage having one or more buttons representing one or more components, respectively, of a building control system;
activating a button of the one or more buttons on the first image to get a second image showing a list of one or more zones and a sort button; and
activating the sort button on the second image to sort the two or more zones according to a default or selected criterion;

14. The method of claim 13, wherein:
activating the sort button on the second image opens up a floating window superimposed on the second image; and
the floating window comprises selectable sorting criteria.

15. The method of claim 13, wherein a selected criterion of the sort button includes one of a group consisting of an alphabetical order, a contextual order, a basis of criticality order, zones having an alarm condition being first in an order, zones having an override being first in an order, an order according to most recent edits, an order of customized preference, and a reversal of a sort order.

16. The method of claim 14, further comprising:
activating a zone icon in the list on the second image to get a third image showing a list of one or more parameters of the zone;
activating a parameter icon on the list of one or more parameters to get a fourth image showing the parameter and parameter adjust buttons;
activating one of the adjust buttons to edit the parameter;
activating an accept button to accept an edit of the parameter or a cancel button to reject the edit;
returning to the third image upon activating the accept or cancel button; and
activating a button or parameter icon to get another first, second, third or fourth image if desired.

17. The method of claim 16, further comprising:
activating a home button to return to the first image having the home page; and
activating can be accomplished with touching a button on the screen.

18. The method of claim 16, wherein the one or more components comprise HVAC, lighting, override, refrigeration, energy and alarms.

19. The method of claim 16, wherein:
each of the second, third and fourth images further comprise previous, next and up buttons; and
each of the second and third images further comprises scroll buttons.

20. The method of claim 16, wherein a maximum of five lines of data are displayed at one time on the display.
